(19) United States
(12) Patent Application Publication
(10) Pub. No.: US 2014/0125456 A1
(43) Pub. Date: May 8, 2014

(54) PROVIDING AN IDENTITY

(71) Applicant: HONEYWELL INTERNATIONAL INC., Morristown, NJ (US)

(72) Inventor: Julie J. Hull Roskos, Forest Lake, MN (US)

(73) Assignee: Honeywell International Inc., Morristown, NJ (US)

(21) Appl. No.: 13/672,254

(22) Filed: Nov. 8, 2012

(51) Int. Cl. G06F 7/02

(52) U.S. Cl. CPC G06F 7/02
USPC 340/5.82

(57) ABSTRACT

Providing an identity is described herein. One method includes receiving identity information associated with a person, determining a level of correlation between the identity information and identity information associated with a known identity, and providing the known identity to a user based, at least in part, on the correlation exceeding a threshold.

### TECHNICAL FIELD

The present disclosure relates to providing an identity.

### BACKGROUND

In various circumstances, a person may not recognize someone they have previously met. For example, people suffering from prosopagnosia may be unable to recognize faces and/or may have difficulty socializing with others. Further, people may suffer from memory deficiencies (e.g., disorders) which may reduce recognition ability. Various people (e.g., sales associates, business owners, politicians, etc.) may interact with various others and may derive benefit from recognizing those with whom they may have previously interacted, for instance.

### BRIEF DESCRIPTION OF THE DRAWINGS

FIG. 1 illustrates a flowchart associated with providing an identity based on received visual identity information in accordance with one or more embodiments of the present disclosure.

FIG. 2 illustrates a flowchart associated with providing an identity based on received audio identity information in accordance with one or more embodiments of the present disclosure.

FIG. 3 illustrates a flowchart associated with providing an identity based on received audio identity information and received visual identity information in accordance with one or more embodiments of the present disclosure.

FIG. 4 illustrates a system for providing an identity in accordance with one or more embodiments of the present disclosure.

FIG. 5 illustrates a method for providing an identity in accordance with one or more embodiments of the present disclosure.

### DETAILED DESCRIPTION

Providing an identity is described herein. For example, embodiments include receiving identity information associated with a person, determining a level of correlation between the identity information and identity information associated with a known identity, and providing the known identity to a user based, at least in part, on the correlation exceeding a threshold.

Embodiments of the present disclosure can provide an identity of a person to a user. As used herein, person can refer to a person other than the user (e.g., a contact, acquaintance, friend, associate, etc.). A provided identity can include, for example, a notification including textual name(s) and/or title(s) of the person. As discussed further below, various notifications (e.g., sounds, vibrations, etc.) can be provided in lieu of, or in addition to, textual information.

People can utilize embodiments of the present disclosure to manage prosopagnosia. For example, embodiments of the present disclosure can allow a user to be provided with an identity of a person the user has previously met without (e.g., before) experiencing embarrassment and/or discomfort associated with not recognizing the person. Users of embodiments of the present disclosure are not limited to those afflicted with prosopagnosia. Various users may desire to be provided with an identity of a person they may have previously met.

Embodiments of the present disclosure can be implemented on existing common devices such as smart phones, for instance. Embodiments of the present disclosure can be implemented using various unnoticeable and/or unobtrusive devices including, for example, glasses, pins, watches, hats, necklaces, and/or hand-held recording devices, among others.

Embodiments of the present disclosure can allow a user to associate identity information of a person with an identity (e.g., profile) of the person. Identity information, as used herein, can refer generally to appearance and/or audio information. For example, identity information can refer to captured images of a person and/or a recording of a person's voice. Various methods of receiving and/or utilizing identity information are discussed further below.

Associating identity information with an identity can be accomplished by various embodiments of the present disclosure without the person's knowledge. For example, an image of the person can be taken using an imaging device concealed within glasses worn by the user and stored in association with the person's identity. Embodiments of the present disclosure can thereafter receive identity information from the same person, determine that the identity information is associated with an identity, and provide the identity to the user.

For example, a user can receive images and/or sound associated with a person, and embodiments of the present disclosure can determine whether the user has previously met the person. If the user has previously met the person (e.g., the user has previously associated the person's identity information with an identity of the person), the identity of the person can be provided to the user. If the user has not met the person, embodiments of the present disclosure can retain (e.g., store) the identity information and allow the user to associate the identity information with an identity of the person.

An identity, as used herein, can refer to an existing (e.g., stored) identity or a created (e.g., new) identity. For example, identities can include titles, business cards, social media contacts, phone contacts, email addresses, screen names, handles, etc., as well as combinations of these and/or other identities. An identity can include information in addition to a person's name. For example, identities can include biographical information relating to the person, the person's family and/or friends, the person's occupation, audio files associated with the person, and/or images associated with the person, among other information.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

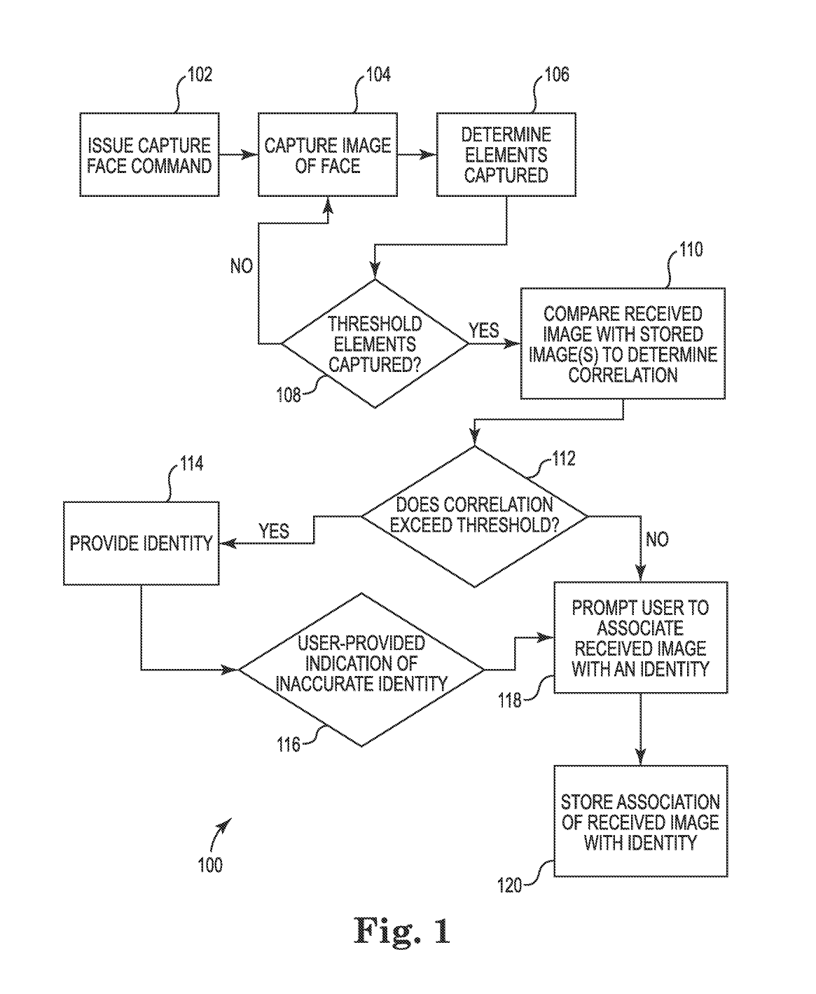

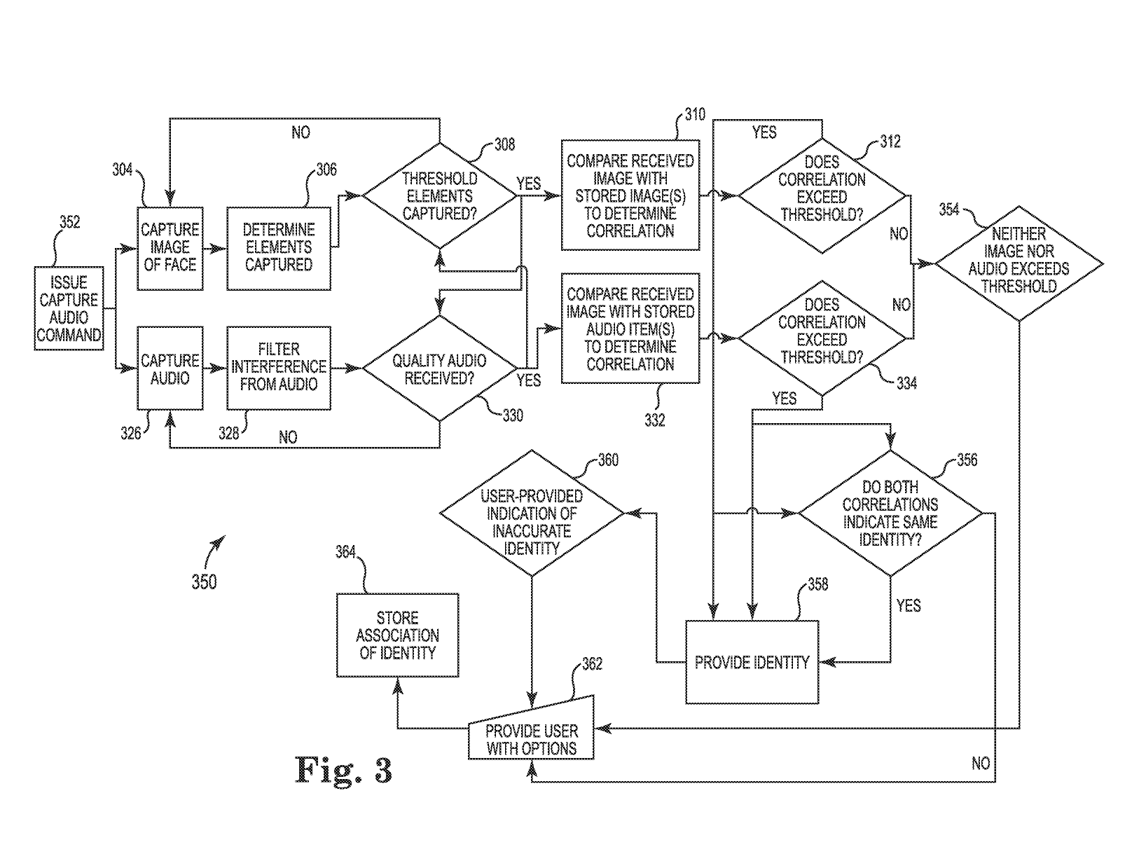

The figures herein follow a numbering convention in which the first digit or digits correspond to the drawing figure number and the remaining digits identify an element or component in the drawing. Similar elements or components between different figures may be identified by the use of similar digits. For example, 104 may reference element “04” in FIG. 1, and a similar element may be referenced as 304 in FIG. 3. As used herein, “a” or “a number of” something can refer to one or more such things. For example, “a number of options” can refer to one or more options.

FIG. 1 illustrates a flowchart 100 associated with providing an identity based on received visual identity information in accordance with one or more embodiments of the present disclosure. As referred to herein, visual identity information can include an image associated with an appearance of a person (e.g., a face of a person). An image (or images) can be captured by an imaging device (e.g., a digital camera). Images can include still images and/or video images.

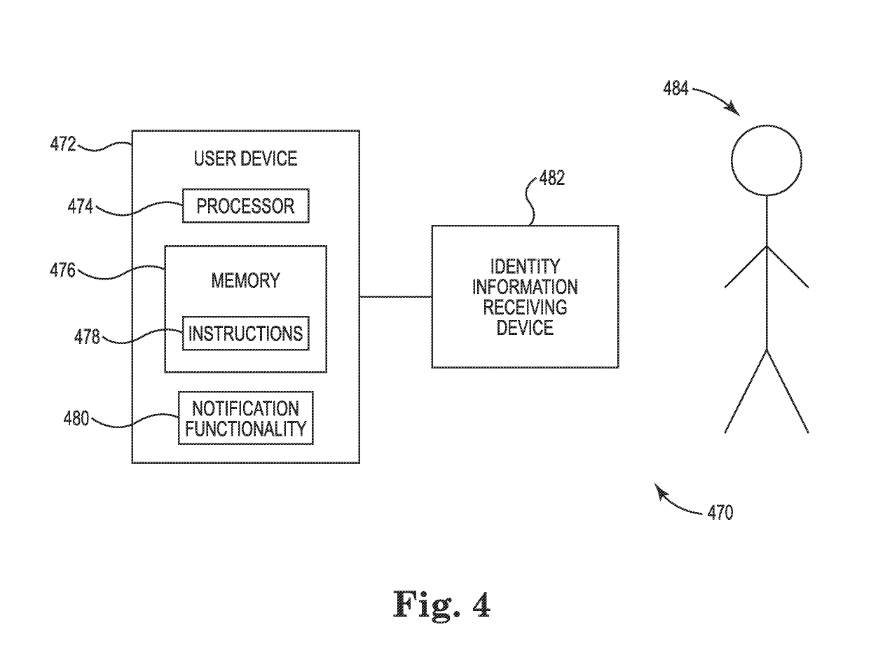

At block 102 a capture face command can be issued. An issue of such a command can include, for example, a user input (e.g., depressing a button), discussed further below. An image of a face can be captured at block 104 responsive to the issuance of the command at block 102. For example, a user can depress a button on a user device and/or an imaging device (discussed below in connection with FIG. 4) to activate an imaging functionality of the device. The user can issue a command on a separate device wired and/or wirelessly connected to the imaging device. Devices can be and/or be concealed within, for example, mobile user devices (e.g., tablets, cell phones, personal digital assistants (PDAs), etc.), watches, glasses, pens, pins, necklaces, purses, etc. In various embodiments, images can be captured without user input (e.g., automatically) and/or with the use of an “autocapture” functionality of the imaging device.

At block 106, a check can be performed to determine whether various (e.g., sufficient) elements were captured in the image. For example, embodiments of the present disclosure can determine whether a threshold number and/or quality of facial elements were captured in the image(s). A determination is made at block 108 whether such a threshold has been exceeded. If the threshold was not exceeded, an image of the face can be captured (e.g., captured again) at block 104 as shown in FIG. 1. Facial elements can include facial features (e.g., eye recognition), colors, gradients, lines, relationships, etc.

If the threshold number and/or quality of captured facial elements was exceeded, the received image can be compared, at block 110, with one or more stored images (and/or data associated therewith) to determine a level of correlation between the received image and at least one of the stored images. Determining a level of correlation can include determining whether a level of correlation exceeds a threshold (e.g., as illustrated at block 112). Determining a level of correlation can include determining whether the received image of the face matches a face of a known identity, identity profile, and/or previously received identity information. Determining a level of correlation can include determining a level of certainty associated with a match and/or determining whether a level of certainty associated with a match exceeds a threshold.

Accordingly, at block 112, it can be determined whether a level of the correlation between the received image and at least one of the stored images exceeds a particular threshold. If the threshold was exceeded, an identity associated with the stored image(s) can be provided to the user at block 114.

Embodiments of the present disclosure include various manners of providing identities. Identities can be provided via a user device (e.g., via a notification functionality of the user device, discussed further below in connection with FIG. 4). A provided identity can include a name, a title, and/or other information associated with an identity of a person.

An identity can be provided in various manners. For example, the user can receive a textual identity including a name of the person. The user can receive various images associated with an identity of the person (e.g., an image of a business card and/or biographical information). The user can receive various sounds associated with an identity. For example, a device can play audio of the person's name (e.g., using text-to-speech functionality via a hidden microphone). Particular sounds (e.g., frequencies and/or tones) can be associated with particular identities. The user can be provided with vibration via a user device. A particular frequency of vibration can be associated with a particular user. Various combinations of the above listed notifications, among others, are included in embodiments of the present disclosure, and the user can be allowed to configure and/or otherwise customize such notifications.

Once provided with the identity, the user can provide an indication at block 116 if the user determines that the provided identity is not accurate. Such an indication can be made using various inputs such as, for example, speech, touchscreen inputs, pulldown menus, etc.

At block 118, if the level of correlation does not exceed the threshold discussed above in connection with block 112, or if the user determines the provided identity is not accurate at block 116, the user can be prompted to associate the received image with an identity at block 118. The identity can be a new (e.g., not previously stored) identity or can be an existing (e.g., stored) identity. The association of the image with the identity can be stored at block 120.

Identities in accordance with embodiments of the present disclosure can be stored in various manners. For example, identities can be incorporated into an existing contact directory (e.g., contact list) stored in a memory of a user device and/or a contact directory accessible by the user device.

Identities can be stored as identity profiles in association with phone numbers, addresses, email addresses, pictures, handles, usernames, screen names, family members, business associates, etc. Identities in accordance with embodiments of the present disclosure can be stored separately from existing contact directories. A user can add, delete, change, and/or otherwise manipulate the storage and usage of identities in a manner analogous to that which the user can manipulate the storage and usage of contacts.

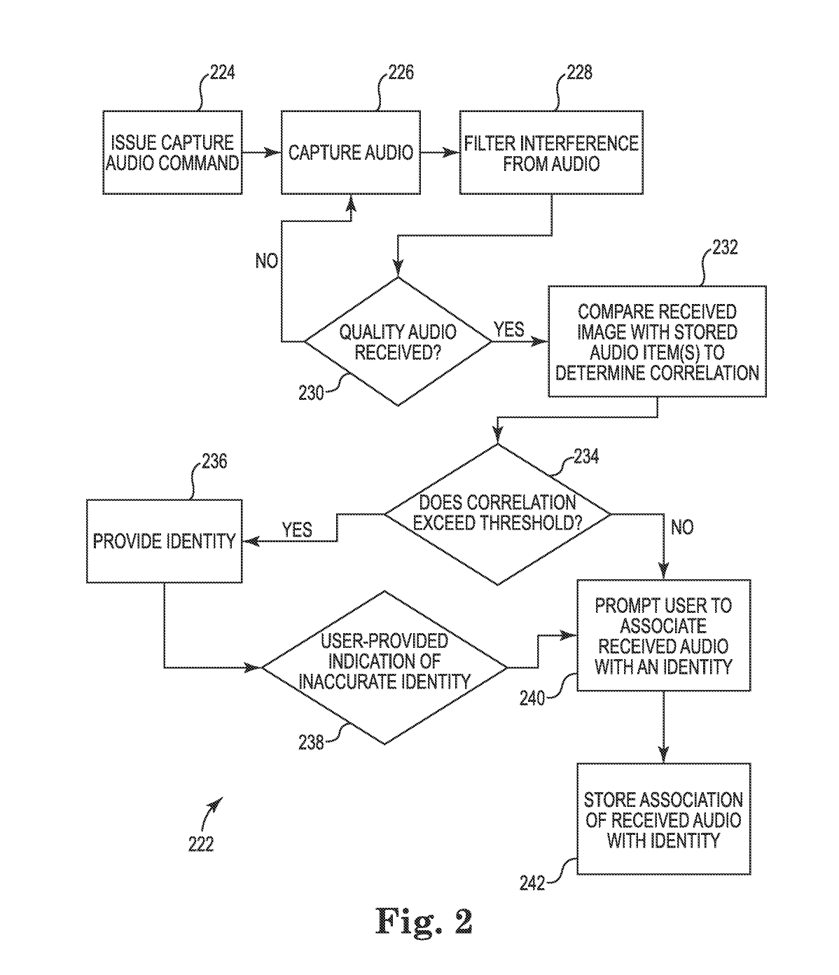

FIG. 2 illustrates a flowchart 222 associated with providing an identity based on received audio identity information in accordance with one or more embodiments of the present disclosure. As referred to herein, audio identity information can include a recording of a voice (or other sounds) of a person (e.g., word(s) and/or phrase(s) uttered by a person). Audio can be captured by an audio capturing device (e.g., a microphone).

At block 224 a capture audio command can be issued. An issue of such a command can include, for example, a user input (e.g., depressing a button), discussed further below. Audio can be captured at block 226 responsive to the issuance of the command at block 224. For example, a user can depress a button on an audio device to activate an audio receiving (e.g., recording) functionality of the device. The user can issue a command on a separate device wired and/or wirelessly connected to the audio device.

Audio devices can be and/or be concealed within, for example, mobile user devices (e.g., tablets, cell phones, personal digital assistants (PDAs), etc.), watches, glasses, pens, pins, necklaces, purses, etc. In various embodiments, audio can be captured without user input (e.g., automatically) and/or with the use of an “autocapture” functionality of the audio device.

At block 228, interference (e.g., noise) can be filtered and/or otherwise removed from the received audio. Such filtering can be performed in various manners known to those of skill in the art. A determination is made at block 230 whether audio of a particular quality (e.g., a threshold-exceeding quality) was received. If the received audio is improper and/or of insufficient quality, audio can be captured (e.g., captured again) at block 226 as shown in FIG. 2.

If the received audio was of particular (e.g., threshold exceeding) quality, the received audio can be compared, at block 232, with one or more stored audio items (e.g., recordings and/or data associated therewith) to determine a level of correlation between the received audio and at least one of the stored audio items. Determining a level of correlation can include determining whether a level of correlation exceeds a threshold (e.g., as illustrated at block 234). Determining a level of correlation can include determining whether the received audio matches audio of a known identity, identity profile, and/or identity information previously received. Determining a level of correlation can include determining a level of certainty associated with a match and/or determining whether a level of certainty associated with a match exceeds a threshold.

Accordingly, at block 234, it can be determined whether a level of the correlation between the received audio and at least one of the stored audio items exceeds a particular threshold. If the threshold was exceeded, an identity associated with the stored audio item(s) can be provided to the user at block 236 (e.g., in one or more of the manners previously discussed in connection with FIG. 1).

Once provided with the identity, the user can provide an indication at block 238 if the user determines that the provided identity is not accurate. At block 240, if the level of correlation does not exceed the threshold discussed above in connection with block 234, or if the user determines the provided identity is not accurate at block 238, the user can associate the received audio with an identity at block 240. The identity can be a new (e.g., not previously stored) identity or can be an existing (e.g., stored) identity. The association of the audio with the identity can be stored at block 242.

FIG. 3 illustrates a flowchart 350 associated with providing an identity based on received audio identity information and received visual identity information in accordance with one or more embodiments of the present disclosure. At block 352, a capture command can be issued in a manner analogous to that previously discussed in connection with FIGS. 1 and/or 2. Such a command can simultaneously initiate capture of audio identity information and visual identity information, for instance.

In a manner analogous to that previously discussed in connection with FIG. 1, images can be captured and/or correlated with existing images. For instance, an image of a face can be captured at block 304 responsive to the issuance of the command at block 352. In a manner analogous to that previously discussed in connection with FIG. 1, a check can be performed at block 306 to determine whether various (e.g., sufficient) elements were captured in the image, and a determination can be made at block 308 to that effect. If not, an image of the face can be captured (e.g., captured again) at block 304 as shown in FIG. 3 and in a manner analogous to that previously discussed in connection with FIG. 1.

If the threshold number and/or quality of captured facial elements was exceeded, the received image can be compared, at block 310, with one or more stored images to determine a level of correlation between the received image and at least one of the stored images in a manner analogous to that previously discussed in connection with FIG. 1. At block 312, a determination can be made regarding whether a level of correlation exceeds a threshold in a manner analogous to that previously discussed in connection with FIG. 1.

In a manner analogous to that previously discussed in connection with FIG. 2, audio can be captured and/or correlated with existing audio items. For instance, audio can be captured at block 326 responsive to the issuance of the command at block 352. In a manner analogous to that previously discussed in connection with FIG. 2, interference (e.g., noise) can be filtered and/or otherwise removed from the received audio at block 328. A determination can be made at block 330 whether audio of a particular quality (e.g., a threshold-exceeding quality) was received in a manner analogous to that previously discussed in connection with FIG. 2. If the received audio is improper or of insufficient quality, audio can be captured (e.g., captured again) at block 326 as shown in FIG. 3, and as previously discussed.

If the received audio was of particular quality, the received audio can be compared, at block 332, with one or more stored audio items (e.g., recordings) to determine a level of correlation between the received audio and at least one of the stored audio items in a manner analogous to that previously discussed in connection with FIG. 2. At block 334, a determination can be made regarding whether a level of correlation exceeds a threshold in a manner analogous to that previously discussed in connection with FIG. 2.

If, at block 354, a determination is made that both the level of correlation between the received audio and one or more of the stored audio items, and the level of correlation between the received image(s) and at least one of the stored images did not exceed the thresholds associated respectively therewith, the user can associate the received audio and/or the received image(s) with an identity (e.g., a new identity) at block 362 (e.g., in a manner analogous to that discussed in connection with FIGS. 1 and/or 2, at blocks 118 and 240, respectively).

If both the correlations determined at block 312 and block 334 exceed the thresholds associated respectively therewith, a determination can be made at block 356 regarding whether they indicate the same proposed identity. If the correlations exceeding the thresholds indicate the same proposed identity, that identity can be provided at block 358 in a manner analogous to that previously discussed. The identity can include a level of correlation and/or an indication (e.g., assurance) that both the received image(s) and the received audio indicate the same identity.

In a manner analogous to that previously discussed in connection with FIGS. 1 and/or 2, if the user determines the provided identity is not accurate at block 360, the user can be provided with a number of options at block 362 including, for example, an option to associate the received image(s) and/or audio with an identity. The identity can be a new (e.g., not previously stored) identity or can be an existing (e.g., stored) identity. The association of the image with the identity can be stored at block 364.

If the correlations exceeding the thresholds indicate different proposed identities (e.g., at block 356), the user can be provided with a number of options at block 362. For example, the user can be provided with each of the proposed identities for review and/or verification. The user can be provided with a level of correlation associated with each proposed identity. The user can be provided one of the proposed identities having a higher level of correlation. The user can be provided one of the proposed identities having a particular (e.g., threshold) correlation. Such options can be user configurable. The user can select and/or input an appropriate identity which can be stored, as previously discussed, at block 364.

In a manner analogous to flow chart 100 and flow chart 222, flow chart 350 can be user configurable. For example, the user can determine a time period allowed for the provision of an identity. The user can elect to receive a particular (e.g., “best matching”) identity even if a particular association threshold was not bet before the time period elapsed.

FIG. 4 illustrates a system 470 for providing an identity in accordance with one or more embodiments of the present disclosure. As shown in FIG. 4, system 470 can include a user device 472 and an identity information receiving device 482 configured to receive identity information associated with a person 484. User device 472 can be a computing device and/or a mobile device, for instance (e.g., a tablet, cell phone, personal digital assistants (PDAs), etc.).

Identity information receiving device 482 can be and/or include various devices for receiving and/or capturing identity information (e.g., visual information and/or audio information) from a person 484. Identity information receiving device 482 can include various imaging device (e.g., digital cameras) and/or audio capturing devices (e.g., microphones) commonly used and/or known. So as to conceal its existence from person 484, identity information receiving device 482 can be implemented as various unnoticeable and/or unobtrusive devices including, for example, glasses, pins, watches, necklaces, hats, and/or hand-held recording devices, among others.

Identity information receiving device 482 can receive (e.g., capture) identity information responsive to a user input such as the depressing of a button, for instance. Identity information receiving device 482 can be equipped with one or more “autocapture” functionalities configured to receive identity information without user input.

User device 472 can be communicatively coupled to identity information receiving device 482. A communicative coupling can include wired and/or wireless connections and/or networks such that data can be transferred in any direction between user device 472 and identity information receiving device 482.

Although one user device is shown, embodiments of the present disclosure are not limited to a particular number of user devices. Additionally, although one identity information receiving device is shown, embodiments of the present disclosure are not limited to a particular number of identity information receiving devices. Additionally, although user device 472 is shown as being separate from identity information receiving device 482, embodiments of the present disclosure are not so limited. For example, identity information receiving device 482 can be included within user device 472.

User device 472 includes a processor 474 and a memory 476. As shown in FIG. 4, memory 476 can be coupled to processor 474. Memory 476 can be volatile or nonvolatile memory. Memory 476 can also be removable (e.g., portable) memory, or non-removable (e.g., internal) memory. For example, memory 476 can be random access memory (RAM) (e.g., dynamic random access memory (DRAM), and/or phase change random access memory (PCRAM)), read-only memory (ROM) (e.g., electrically erasable programmable read-only memory (EEPROM), and/or compact-disk read-only memory (CD-ROM)), flash memory, a laser disk, a digital versatile disk (DVD), and/or other optical disk storage), and/or a magnetic medium such as magnetic cassettes, tapes, or disks, among other types of memory.

Further, although memory 476 is illustrated as being located in user device 222, embodiments of the present disclosure are not so limited. For example, memory 476 can also be located internal to another computing resource, e.g., enabling computer readable instructions to be downloaded over the Internet or another wired or wireless connection.

Memory 476 can store a set of executable instructions 478, such as, for example, computer readable instructions (e.g., software), for providing an identity in accordance with one or more embodiments of the present disclosure. For example, instructions 478 can include instructions for creating a respective identity profile associated with each contact of a plurality of contacts, wherein each profile includes at least one of visual information associated with the contact and voice information associated with the contact. Instructions 478 can include instructions for receiving at least one of visual information associated with a person and voice information associated with the person.

Instructions 478 can include instructions for determining a correlation between the at least one of the visual information associated with the person and the voice information associated with the person and at least one identity profile. Memory 476 can store received images and/or audio. Memory 476 can store existing (e.g., known) identities and/or identity profiles associated with images and/or audio.

Processor 474 can execute instructions 478 stored in memory 476 to provide an identity in accordance with one or more embodiments of the present disclosure. For example, processor 474 can execute instructions 478 stored in memory 476 to provide a portion of an identity profile having a particular correlation.

User device 472 can include a notification functionality 480. Notification functionality 480 can be various functionalities of user device 472 configured to provide a notification (discussed above) to the user. For example, notification functionality 480 can include a display element configured to provide text and/or images to the user. Notification functionality 480 can include a vibration functionality of user device 472. Notification functionality can include an audio functionality configured to play various sounds and/or tones.

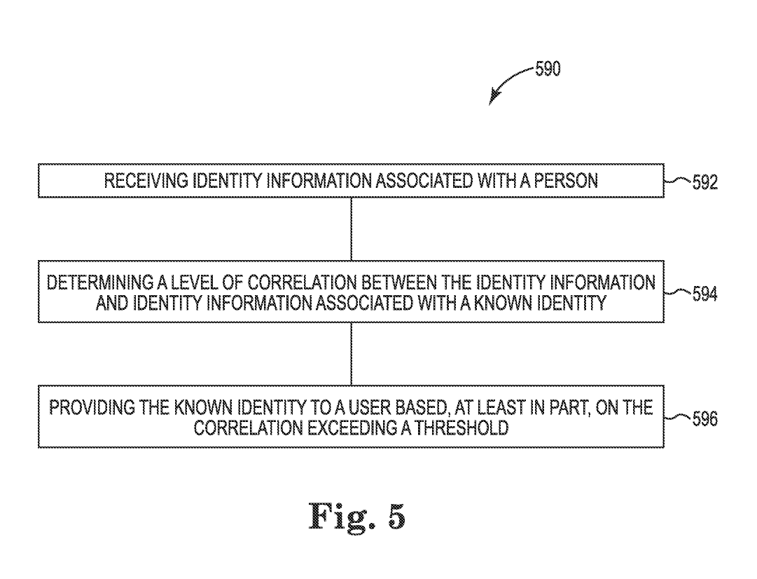

FIG. 5 illustrates a method 590 for providing an identity in accordance with one or more embodiments of the present disclosure. Method 590 can be performed by user device 472, discussed above in connection with FIG. 4, for instance.

At block 592, method 590 includes receiving identity information associated with a person. Identity information (e.g., visual information and/or audio information) can be received (e.g., from identity information receiving device 482) in a manner analogous to that previously discussed in connection with FIGS. 1, 2, 3, and/or 4, for instance.

At block 594, method 590 includes determining a level of correlation between the identity information and identity information associated with a known identity. A level of correlation between the identity information and identity information associated with a known and/or existing identity can be determined in a manner analogous to that previously discussed in connection with FIGS. 1, 2, 3, and/or 4, for instance.

At block 596, method 590 includes providing the known identity to a user based, at least in part, on the correlation exceeding a threshold. A known identity can be provided (e.g., by notification functionality 480 of user device 472) in a manner analogous to that previously discussed in connection with FIGS. 1, 2, 3, and/or 4, for instance.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for providing an identity, comprising:
receiving identity information associated with a person;
determining a level of correlation between the identity information and identity information associated with a known identity; and
providing the known identity to a user based, at least in part, on the correlation exceeding a threshold.

2. The method of claim 1, wherein the method includes receiving appearance features associated with a face of the person.

3. The method of claim 1, wherein the method includes receiving audio features associated with a voice of the person.

4. The method of claim 1, wherein the method includes issuing a prompt associated with storing the received identity information in connection with a new identity responsive to the correlation not exceeding the threshold.

5. The method of claim 1, wherein the method includes determining a level of certainty associated with the known identity and providing the level of certainty along with the known identity.

6. The method of claim 1, wherein the method includes limiting a duration of the method responsive to a user configuration.

7. A system for providing an identity, comprising
a device configured to:
receive a first user input to obtain identity information associated with a person; and
receive a second user input to obtain subsequent identity information associated with the person; and
a user device configured to:
receive the identity information;
store an association of the identity information with a known identity;
receive the subsequent identity information;
determine a level of correlation between the subsequent identity information and the identity information; and
provide a notification associated with the known identity responsive to the level of correlation exceeding a threshold.

8. The system of claim 7, wherein the device includes an imaging device.

9. The system of claim 7, wherein the device includes an audio recording device.

10. The system of claim 7, wherein the notification includes a particular audio tone associated with the known identity.

11. The system of claim 7, wherein the notification includes audio of a name of the person.

12. The system of claim 7, wherein the user device is configured to store the association of the identity information with the known identity as a portion of an existing contact in a memory of the user device.

13. The system of claim 7, wherein the notification includes a particular vibration associated with the known identity.

14. A non-transitory computer-readable medium storing instructions thereon executable by a processor to:
create a respective identity profile associated with each contact of a plurality of contacts, wherein each profile includes at least one of visual information associated with the contact and voice information associated with the contact;
receive at least one of visual information associated with a person and voice information associated with the person;
determine a correlation between the at least one of the visual information associated with the person and the voice information associated with the person and at least one identity profile; and
provide a portion of an identity profile having a particular correlation.

15. The computer-readable medium of claim 14, wherein the instructions include instructions executable by the processor to receive the visual information and the voice information simultaneously in response to a user command.

16. The computer-readable medium of claim 14, wherein the instructions include instructions executable by the processor to allow the user to associate the at least one of visual information associated with the person and voice information associated with the person with a new identity profile in response to a determination that the level of the correlation between the at least one of the visual information associated with the person and the voice information associated with the person and at least one identity profile does not exceed a threshold.

17. The computer-readable medium of claim 14, wherein the instructions include instructions executable by the processor to provide the portion of the identity profile in response to a determination that the correlation between the at least one of the visual information associated with the person and the voice information associated with the person and the at least one identity profile exceeds a threshold.

18. The computer-readable medium of claim 14, wherein the instructions include instructions executable by the processor to:
determine that the visual information associated with the person and the voice information associated with the person correlates with a same identity profile; and
provide a portion of the same identity profile.

19. The computer-readable medium of claim 14, wherein the instructions include instructions executable by the processor to:
determine that the visual information associated with the person correlates to a first identity profile;
determine that the voice information associated with the person correlates to a second identity profile; and
provide a respective portion of each of the first and second identity profiles.

20. The computer-readable medium of claim 14, wherein the instructions include instructions executable by the processor to:
determine that the visual information associated with the person correlates to a first identity profile;
determine that the voice information associated with the person correlates to a second identity profile; and
provide a one of the first and second identity profiles having a greater level of correlation.
